(19) United States
(12) Patent Application Publication
(10) Pub. No.: US 2021/0092466 A1
(43) Pub. Date: Mar. 25, 2021

(54) INFORMATION PROCESSING APPARATUS, INFORMATION PROCESSING METHOD, AND PROGRAM

(71) Applicant: SONY CORPORATION, Tokyo (JP)

(72) Inventors: Satoshi SUZUKI, Tokyo (JP); Hiroshi YAMAGUCHI, Tokyo (JP); Tomohiro OOI, Chiba (JP); Koji FURUSAWA, Tokyo (JP)

(73) Assignee: SONY CORPORATION, Tokyo (JP)

(21) Appl. No.: 16/971,886

(22) PCT Filed: Feb. 14, 2019
(86) PCT No.: PCT/JP2019/005187

§ 371 Date: Aug. 21, 2020

(30) Foreign Application Priority Data
Feb. 28, 2018 (JP) 2018-035080

(51) Int. Cl. H04N 21/234; G06T 19/00; G06F 3/01; H04N 5/262; H04N 5/268; H04N 21/2662; H04N 21/2343; H04N 21/431

(52) U.S. Cl. CPC H04N 21/23424; G06T 19/006; G06F 3/013; H04N 21/431; H04N 5/268; H04N 21/2662; H04N 21/234345; H04N 5/2628

(57) ABSTRACT

There is provided an information processing apparatus, an information processing method, and a program that enable improvement of user convenience, the information processing apparatus including a display control part that controls a display device to display a transition image that changes substantially continuously and includes a background image having an information amount that is smaller than at least one of a background image of a first video or a background image of a second video, when switching from the first video viewable from a first viewpoint to the second video viewable from a second viewpoint different from the first viewpoint. The present technology can be applied to, for example, a device that displays a video on a head mounted display.

### TECHNICAL FIELD

The present technology relates to an information processing apparatus, an information processing method, and a program, and in particular, to an information processing apparatus, an information processing method, and a program that enable improvement of user convenience.

### BACKGROUND ART

In recent years, research and development of a technology for providing a virtual reality (VR) function using devices such as a head mounted display (HMD) have been actively performed (for example, see Patent Document 1).

Patent Document 1 discloses a technology of generating and displaying an image of a game field of which a position indicated by a marker is changed to a viewpoint position when the position indicated by the marker is selected as the viewpoint position in a head mounted display connected to a game machine.

### CITATION LIST

### Patent Document

Patent Document 1: Japanese Patent Application Laid-Open No. 2017-102297

### SUMMARY OF THE INVENTION

### Problems to be Solved by the Invention

By the way, in a device such as a head mounted display, when switching a viewpoint of a video, for example, a user may lose own viewing direction and position, and may get motion sickness due to sudden change of the video or difference in the change of the video from actual body motions.

Therefore, in a device such as a head mounted display, there is a need for a technique for avoiding such an inconvenient event associated with switching of the viewpoint of a video and improving user convenience.

The present technology has been made in view of such circumstances, and is intended to enable improvement of user convenience.

### Solutions to Problems

An information processing apparatus according to an aspect of the present technology is an information processing apparatus including a display control part that controls a display device to display a transition image that changes substantially continuously and includes a background image having an information amount that is smaller than at least one of a background image of a first video or a background image of a second video, when switching from the first video viewable from a first viewpoint to the second video viewable from a second viewpoint different from the first viewpoint.

The information processing apparatus according to an aspect of the present technology may be an independent apparatus, or may be an internal block included in one device.

An information processing method and a program according to an aspect of the present technology are an information processing method and a program corresponding to the above-described information processing apparatus according to an aspect of the present technology.

In the information processing apparatus, an information processing method, and a program according to an aspect of the present technology, a display device is controlled to display a transition image that changes substantially continuously and includes a background image having an information amount that is smaller than at least one of a background image of a first video or a background image of a second video, when switching from the first video viewable from a first viewpoint to a second video viewable from a second viewpoint different from the first viewpoint.

### Effects of the Invention

According to an aspect of the present technology, user convenience can be improved.

Note that the effects described herein are not necessarily limited, and any of the effects described in the present disclosure may be applied.

### BRIEF DESCRIPTION OF DRAWINGS

FIG. 1 is a block diagram showing a configuration example of a video reproduction system according to an embodiment to which the present technology is applied.

FIG. 2 is a diagram showing a display example of an omnidirectional live action video captured by an imaging device installed in a soccer stadium.

FIG. 3 is a diagram showing an example of the omnidirectional live action video before viewpoint movement in the soccer stadium.

FIG. 4 is a diagram showing a first example of a CG video at the time of viewpoint movement in the soccer stadium.

FIG. 5 is a diagram showing a second example of a CG video at the time of viewpoint movement in the soccer stadium.

FIG. 6 is a diagram showing a third example of a CG video at the time of viewpoint movement in the soccer stadium.

FIG. 7 is a diagram showing an example of an omnidirectional live action video after viewpoint movement in the soccer stadium.

FIG. 8 is a flowchart for explaining a flow of reproduction and display control processing.

FIG. 9 is a timing chart showing an example of highlight video distribution of soccer.

FIG. 10 is a diagram showing a display example of a miniature CG video in the field.

FIG. 11 is a diagram showing an example of a distance to a field of a user's line-of-sight at the time of displaying an omnidirectional live action video.

FIG. 12 is a diagram showing an example of a distance to a field of a user's line-of-sight at the time of displaying a miniature CG video.

FIG. 13 is a diagram showing a first example of a miniature CG video of a goal scene of soccer.

FIG. 14 is a diagram showing a second example of a miniature CG video of a goal scene of soccer.

FIG. 15 is a diagram showing a third example of a miniature CG video of a goal scene of soccer.

FIG. 16 is a diagram showing a first example of a miniature CG video of a musical instrument arrangement of an orchestra.

FIG. 17 is a diagram showing a second example of a miniature CG video of a musical instrument arrangement of an orchestra.

FIG. 18 is a diagram showing a third example of a miniature CG video of a musical instrument arrangement of an orchestra.

FIG. 19 is a timing chart showing an example of music live video distribution.

FIG. 20 is a diagram showing an example of an omnidirectional live action video in a first viewpoint in music live video distribution.

FIG. 21 is a diagram showing an example of a CG video in music live video distribution.

FIG. 22 is a diagram showing an example of an omnidirectional live action video in a second viewpoint in music live video distribution.

FIG. 23 is a diagram showing a configuration example of a computer.

### MODE FOR CARRYING OUT THE INVENTION

Hereinafter, embodiments of the present technology will be described with reference to the drawings. Note that the description will be given in the following order.
1. First embodiment: Video reproduction of soccer game
2. Second embodiment: Video reproduction of soccer game (display scale change)
3. Third embodiment: Video reproduction of orchestra concert (display scale change)
4. Fourth embodiment: Music live video reproduction
5. Modification
6. Computer configuration

### 1. First Embodiment

(Configuration Example of Video Reproduction System)

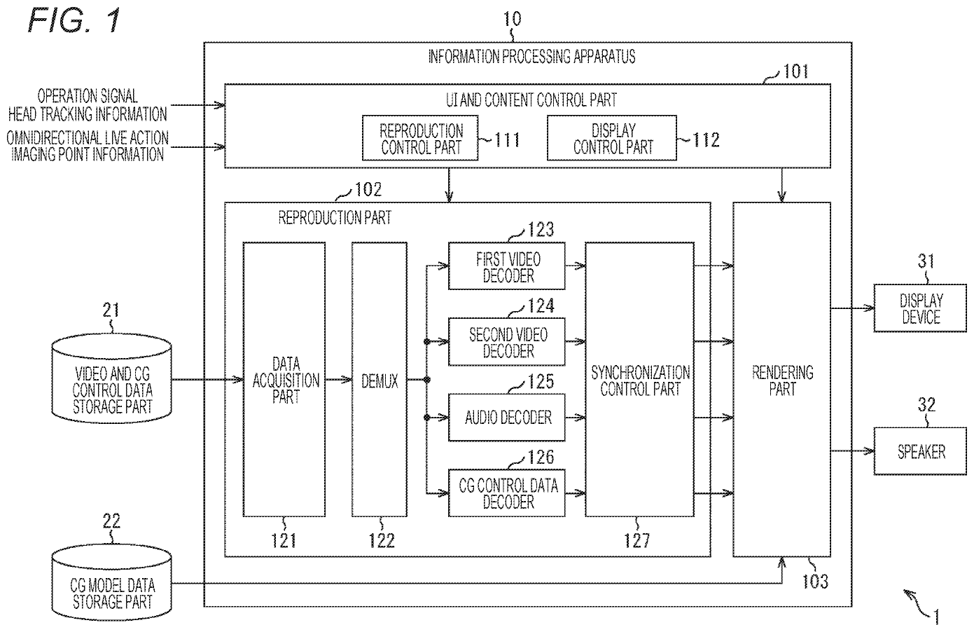

FIG. 1 is a block diagram showing a configuration example of a video reproduction system according to an embodiment to which the present technology is applied.

A video reproduction system 1 is a system that processes data such as image data captured by an imaging device such as an omnidirectional camera or computer graphics (CG) model data, and causes a display device such as a head mounted display to display a video such as an omnidirectional live action video or a CG video obtained as a result of the processing.

In FIG. 1, the video reproduction system 1 includes: an information processing apparatus 10 that performs central processing; a video and CG control data storage part 21 and a CG model data storage part 22 that store data input to the information processing apparatus 10; and a display device 31 and a speaker 32 that present data output from the information processing apparatus 10.

The information processing apparatus 10 is configured as an electronic device such as a game machine, a personal computer, or a unit equipped with a dedicated processor, for example. The information processing apparatus 10 includes a UI and content control part 101, a reproduction part 102, and a rendering part 103.

The UI and content control part 101 includes, for example, a central processing unit (CPU), a microprocessor, and the like. The UI and content control part 101 operates as a central control device in the information processing apparatus 10 such as various arithmetic processes and operation control.

The UI and content control part 101 controls the reproduction part 102 and the rendering part 103 to control the display and reproduction of a user interface (UI) and content.

For example, an operation signal according to an operation on an operation device (for example, a controller or the like) by a user wearing the head mounted display is input to the UI and content control part 101. The UI and content control part 101 controls the operation of each part of the information processing apparatus 10 on the basis of the input operation signal.

Furthermore, information obtained from a tracking signal according to a motion of the head of the user wearing the head mounted display (hereinafter, referred to as head tracking information), and information regarding the imaging position and the imaging direction of the omnidirectional live action video (hereinafter, referred to as omnidirectional live action imaging point information) are input to the UI and content control part 101.

Note that the omnidirectional live action video is a video obtained by processing image data captured by an imaging device such as an omnidirectional camera (omnidirectional camera) installed, for example, in a predetermined facility or outdoors, and is a 360-degree panoramic video in all directions, up, down, left, and right.

The UI and content control part 101 performs predetermined arithmetic processing (for example, arithmetic processing for calculating a user's viewpoint or calculating a display angle of view) using at least one of input head tracking information or omnidirectional live action imaging point information. The UI and content control part 101 controls the reproduction part 102 and the rendering part 103 on the basis of an arithmetic processing result obtained by predetermined arithmetic processing.

The UI and content control part 101 includes a reproduction control part 111 and a display control part 112.

The reproduction control part 111 controls reproduction processing performed by the reproduction part 102. The display control part 112 controls rendering processing performed by the rendering part 103.

Under the control of the reproduction control part 111, the reproduction part 102 processes video data and audio data of content input thereto and performs reproduction processing for reproducing the content.

The reproduction part 102 includes a data acquisition part 121, a demux 122, a first video decoder 123, a second video decoder 124, an audio decoder 125, a CG control data decoder 126, and a synchronization control part 127.

The data acquisition part 121 acquires input data related to the content to be reproduced from the video and CG control data storage part 21 and supplies the input data to the demux 122.

Here, for example, various types of data such as data of the omnidirectional live action video obtained from image data captured by an imaging device such as an omnidirectional camera, and CG control data for controlling a CG video are recorded in the video and CG control data storage part 21.

However, the data recorded in the video and CG control data storage part 21 is subjected to encoding processing according to a predetermined method and is encoded. Furthermore, the CG control data is control data of a CG model that changes depending on time, and includes, for example, motion data, position information, and vertex and mesh change information.

The demux 122 separates the input data supplied from the data acquisition part 121 into encoded video data, encoded audio data, and encoded CG control data. However, here, as input data, two series of encoded video data (first encoded video data and second encoded video data) from different imaging devices (for example, omnidirectional camera) are included.

The demux 122 supplies, among the pieces of data obtained by separating the input data, the first encoded video data to the first video decoder 123, the second encoded video data to the second video decoder 124, the encoded audio data to the audio decoder 125, and the encoded CG control data to the CG control data decoder 126.

The first video decoder 123 decodes the first encoded video data supplied from the demux 122 according to a predetermined decoding method, and supplies the resulting first video data to the synchronization control part 127.

The second video decoder 124 decodes the second encoded video data supplied from the demux 122 according to a predetermined decoding method, and supplies the resulting second video data to the synchronization control part 127.

The audio decoder 125 decodes the encoded audio data supplied from the demux 122 according to a predetermined decoding method, and supplies the resulting audio data to the synchronization control part 127.

The CG control data decoder 126 decodes the encoded CG control data supplied from the demux 122 according to a predetermined decoding method, and supplies the resulting CG control data to the synchronization control part 127.

The first video data from the first video decoder 123, the second video data from the second video decoder 124, the audio data from the audio decoder 125, and the CG control data from the CG control data decoder 126 are input to the synchronization control part 127.

The synchronization control part 127 performs synchronization control of synchronizing the first video data, the second video data, the audio data, and the CG control data input thereto, and supplies each of the synchronized first video data, second video data, audio data, and CG control data to the rendering part 103.

The first video data, the second video data, the audio data, and the CG control data are synchronously input to the rendering part 103 from the synchronization control part 127 of the reproduction part 102. Furthermore, the CG model data is input to the rendering part 103 from the CG model data storage part 22.

Here, in the CG model data storage part 22, various types of data such as CG model data, for example, are recorded. However, the CG model data is data of the CG model that does not change depending on time, and includes, for example, mesh data, texture data, material data, and the like.

Under the control of the display control part 112, the rendering part 103 processes video data and audio data of content input thereto and CG data and performs rendering processing for outputting video and sound of content and CG.

Specifically, the rendering part 103 performs rendering processing on first video data or second video data, and outputs the resulting video output data to the display device 31 via a predetermined interface. Therefore, the display device 31 displays a video of content such as an omnidirectional live action video on the basis of the video output data output from (the rendering part 103 of) the information processing apparatus 10.

Furthermore, the rendering part 103 performs rendering processing on audio data, and outputs the resulting sound output data to the speaker 32 via a predetermined interface. Therefore, the speaker 32 outputs sound synchronized with the video of content such as an omnidirectional live action video on the basis of the sound output data output from (the rendering part 103 of) the information processing apparatus 10.

Moreover, the rendering part 103 performs rendering processing on CG model data on the basis of CG control data, and outputs the resulting CG video output data to the display device 31. Therefore, the display device 31 displays a CG video on the basis of the CG video output data output from (the rendering part 103 of) the information processing apparatus 10.

Here, in a case where the UI and content control part 101 performs display switching processing of switching between an omnidirectional live action video and a CG video, for example, the following processing is performed according to the switching target.

That is, at the time of switching from the omnidirectional live action video to the CG video, the UI and content control part 101 adjusts the position of the CG rendering camera so that the viewpoint direction of the omnidirectional live action video and the CG video match, and gives an instruction to the rendering part 103.

On the other hand, at the time of switching from the CG video to the omnidirectional live action video, the UI and content control part 101 performs, for example, the following three processes for transition to the omnidirectional live action video in the same viewpoint.

First, from among a plurality of omnidirectional live action videos, an omnidirectional live action video closest to the CG video at the time of switching is selected. Next, an instruction is given to the rendering part 103 to move the CG rendering camera position to the viewpoint of the imaging device (for example, the omnidirectional camera) from which the selected omnidirectional live action video has been captured. Then, an instruction is given to the rendering part 103 to change the front viewpoint direction of the omnidirectional live action video after the transition, according to the direction that the user has viewed in the CG.

Note that, here, since the control data (CG control data) of the CG model held by the data of the time stamp synchronized with the video and sound is passed to the rendering part 103 in synchronization, for example, the following three processes can be performed.

That is, first, it is possible to synchronize a plurality of omnidirectional live action videos and CG videos so that a scene at the same timing can be represented even when the videos are switched. Secondly, it is possible to perform trick play such as fast forward and rewind, for example, by synchronization of the omnidirectional live action video and the CG video. Thirdly, even if switching is made between a plurality of omnidirectional live action videos and CG videos, sound synchronized with those videos can be continuously reproduced.

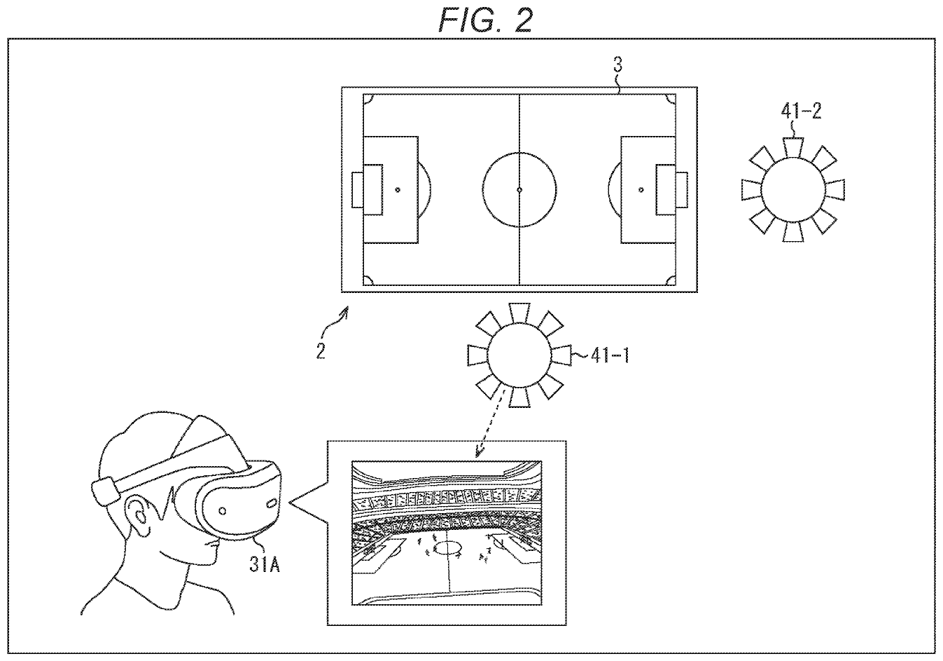

The display device 31 is configured as an electronic device having a display, such as a head mounted display or a smartphone, for example. Note that, in the following description, a head mounted display (a head mounted display 31A in FIG. 2 as described later) will be described as an example of the display device 31.

Furthermore, in the configuration shown in FIG. 1, the speaker 32 is shown as the sound output device. However, the sound output device is not limited to the speaker 32. For example, a user wearing a head mounted display on the head may further insert an earphone into the ear (or wear headphones) so that sound is output therefrom.

Note that the information processing apparatus 10, the display device 31, and the speaker 32 can be connected by a wire via a cable compliant with a predetermined standard, or can be connected by wireless communication compliant with a predetermined standard, for example.

The video reproduction system 1 is configured as described above.

Note that, in FIG. 1, description has been made that head tracking information is used as the tracking information used in the arithmetic processing in the UI and content control part 101. However, for example, position tracking information indicating a spatial position of a head mounted display, eye tracking information according to a motion of the user's line-of-sight, or the like may be further used.

Furthermore, in FIG. 1, description has been made that various types of data such as data of an omnidirectional live action video, CG control data, and CG model data are recorded in, for example, the video and CG control data storage part 21 and the CG model data storage part 22 including a large-capacity recording medium such as a hard disk drive (HDD), a semiconductor memory, or an optical disk, and the information processing apparatus 10 obtains input data therefrom. However, the data may be obtained through another route.

For example, a communication I/F may be provided in the information processing apparatus 10 so as to be connectable to the Internet so that various types of data such as data of omnidirectional live action video distributed from a server on the Internet are received and input to the reproduction part 102. Furthermore, a tuner may be provided in the information processing apparatus 10 to enable reception of a broadcast wave via an antenna so that various types of data such as data of an omnidirectional live action video obtained from the broadcast wave are input to the reproduction part 102.

(Animation Display at the Time of Viewpoint Movement)

FIG. 2 shows a display example of an omnidirectional live action video captured by an imaging device installed in a soccer stadium 2.

Although FIG. 2 shows a field 3 in the soccer stadium 2, actually, a stand is provided so as to surround the field 3. In this example, a camera 41-1 is installed on the upper part of the stand on the near side with respect to the field 3, and a camera 41-2 is installed behind one goal fixed to the field 3.

The cameras 41-1 and 41-2 are, for example, omnidirectional cameras, and are imaging devices capable of imaging an omnidirectional live action video which is a 360-degrees panoramic video of all directions, up, down, right and left. Note that, in the following description, an omnidirectional live action video captured by an omnidirectional camera will be described as an example, but the device is not limited to the omnidirectional camera, and a live action video captured by another imaging device may be used. For example, a live action video (for example, a video having a viewing angle of 180 degrees) captured by imaging by attaching a fisheye lens or a wide-angle lens to a normal camera may be used.

The camera 41-1 can capture an omnidirectional live action video according to the installation position of the upper part of the stand on the near side. Furthermore, the camera 41-2 can capture an omnidirectional live action video according to the installation position behind the goal. Note that data of the omnidirectional live action video captured by the cameras 41-1 and 41-2 can be recorded in the video and CG control data storage part 21 (FIG. 1).

Then, for example, the omnidirectional live action video obtained in this manner is reproduced by the information processing apparatus 10 (FIG. 1) and displayed on the head mounted display 31A as the display device 31, so that the user wearing the head mounted display 31A can enjoy realistic feeling as if he/she was at the soccer stadium 2.

For example, the camera 41-1 allows the head mounted display 31A to display an omnidirectional live action video from a direction of the upper part of the stand. Furthermore, for example, the camera 41-2 allows the head mounted display 31A to display an omnidirectional live action video from a direction from back side of the goal.

Note that the head mounted display 31A is a display device that is mounted to the head so as to cover both eyes of the user and allows the user to view a still image or a moving image displayed on a display screen provided in front of the user, for example. The target displayed on the head mounted display 31A is, for example, content of, in addition to a sports program such as a soccer program, a video of a concert or music live, a TV program, a movie, a game image, or the like.

Furthermore, FIG. 2 shows a case where the camera 41-1 is installed on the upper part of the stand on the near side and the camera 41-2 is installed behind one goal, but the installation position of the camera 41 is not limited to this. For example, an arbitrary number of the cameras can be installed at an arbitrary position in the soccer stadium 2, such as an upper part of a stand on the far side (main stand or back stand) or behind the other goal. Furthermore, in the following description, the camera 41-1, camera 41-2 will be simply described as the camera 41 unless it is particularly necessary to distinguish them.

Here, a case is assumed where the omnidirectional live action video displayed on the head mounted display 31A is switched from the omnidirectional live action video in the upper part of the stand captured by the camera 41-1 to the omnidirectional live action video behind the goal captured by the camera 41-2.

At this time, the information processing apparatus 10 (FIG. 1) causes, as the display of the head mounted display 31A, display of an animation of the viewpoint movement by switching to the consecutive CG video display during the viewpoint movement between a first viewpoint in which the omnidirectional live action video in the upper part of the stand can be viewed to a second viewpoint in which the omnidirectional live action video behind the goal can be viewed.

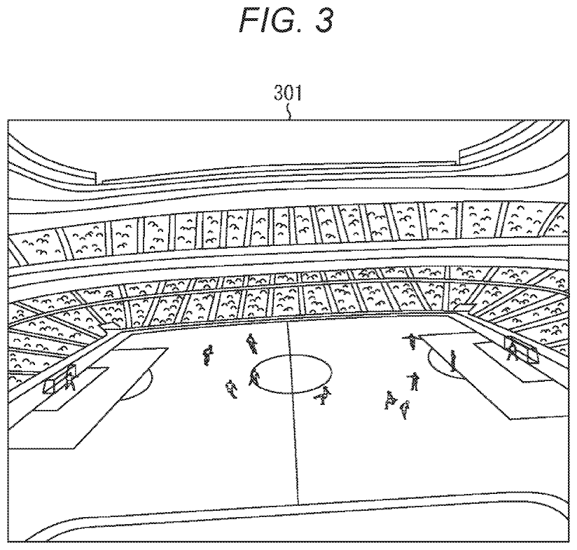

FIG. 3 shows an example of an omnidirectional live action video before the viewpoint movement, displayed on the head mounted display 31A. In FIG. 3, the head mounted display 31A displays an omnidirectional live action video 301 having a viewpoint corresponding to the line-of-sight direction of the user viewing the omnidirectional live action video captured by the camera 41-1 on the upper part of the stand.

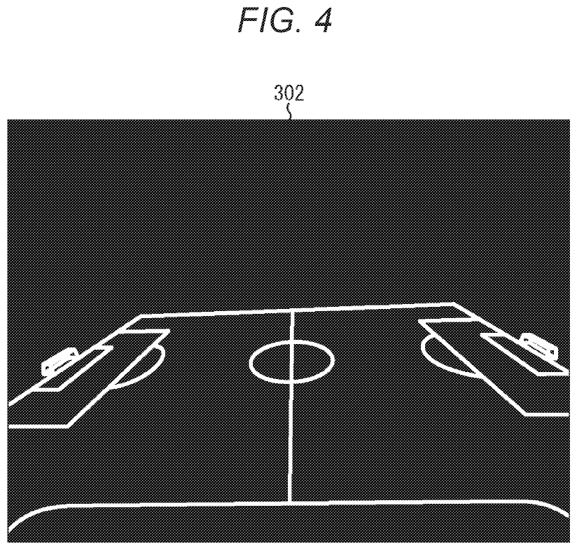

FIGS. 4 to 6 show an example of a CG video displayed during the viewpoint movement on the head mounted display 31A. Note that it is assumed that the CG videos shown in FIGS. 4 to 6 are displayed in chronological order in that order.

First, as shown in FIG. 4, a CG video 302 of which viewpoint is from a direction of the upper part of the stand is displayed on the head mounted display 31A. That is, the viewpoint of the CG video 302 substantially matches the viewpoint of the omnidirectional live action video 301 (FIG. 3) before the above-described viewpoint movement.

Furthermore, in the CG video 302, a stand, spectators, players, and the like are not included, and a line marking the field 3 (for example, a halfway line, a touch line, a goal line, or the like) and the goal set at the center of each goal line are represented by wire frame (represented only by the outline), as compared to the omnidirectional live action video 301 (FIG. 3).

That is, the CG video 302 includes, for example, an image represented by a predetermined single color such as black or blue as a background image, and has an information amount that is smaller than the background image of the omnidirectional live action video 301. Note that the wire frame is one of three-dimensional modeling and rendering methods, and is a method of representation by a set of lines including only three-dimensional sides.

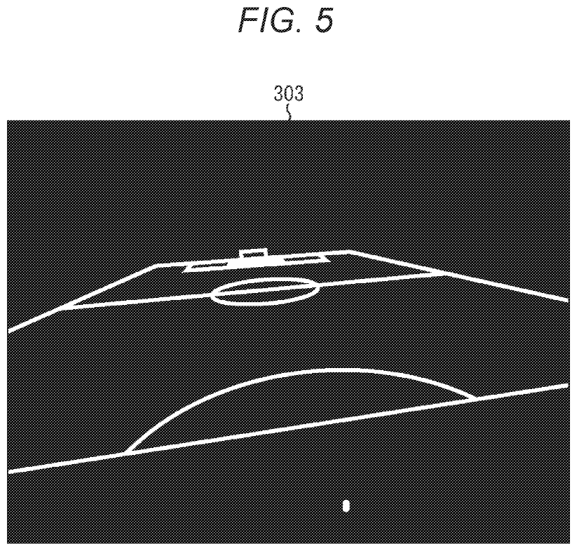

Next, as shown in FIG. 5, a CG video 303 having a different viewpoint from the CG video 302 (FIG. 4) is displayed on the head mounted display 31A. For example, the viewpoint of the CG video 303 is an arbitrary position on a trajectory connecting the installation position of the camera 41-1 in the upper part of the stand and the installation position of the camera 41-2 behind the goal.

Furthermore, the CG video 303 represents, by the wire frame, a line or a goal marking the field 3, similarly to the CG video 302 (FIG. 4). Moreover, the CG video 303 includes an image represented by a predetermined single color such as black, for example, as a background image, similarly to the CG video 302 (FIG. 4).

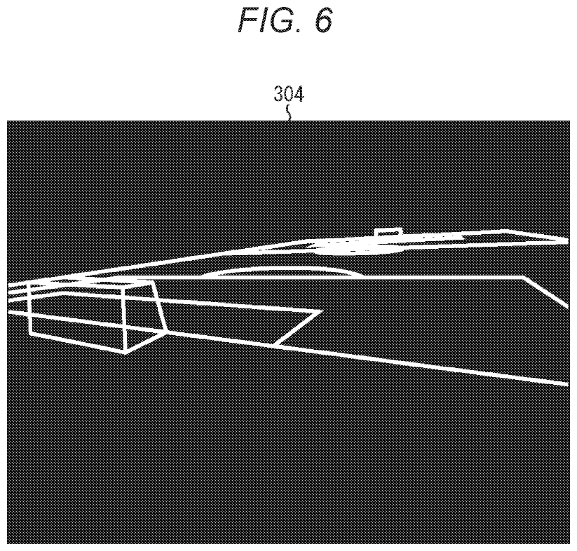

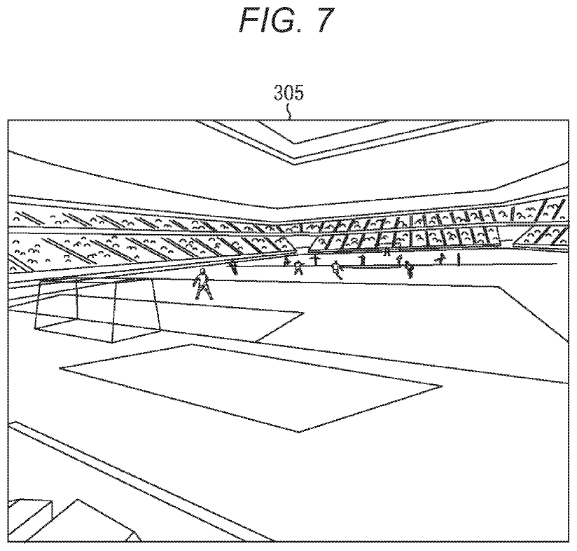

Next, as shown in FIG. 6, a CG video 304 of which a viewpoint is in a direction from back side of the goal is displayed on the head mounted display 31A. That is, the viewpoint of the CG video 304 substantially matches the viewpoint of the omnidirectional live action video 305 (FIG. 7) after the viewpoint movement described later.

Furthermore, the CG video 304 represents, by the wire frame, a line and a goal for marking the field 3, similarly to the CG video 302 (FIG. 4) and the CG video 303 (FIG. 5). Moreover, the CG video 304 includes an image represented by a predetermined single color such as black, for example, as a background image.

As described above, in the head mounted display 31A, when switching the viewpoint from the omnidirectional live action video of the upper part of the stand to the omnidirectional live action video behind the goal, the information processing apparatus 10 (FIG. 1) causes display of continuously changing CG videos (so to speak, transition images) like the CG video 302 (FIG. 4), the CG video 303 (FIG. 5), and the CG video 304 (FIG. 6) represented by wire frame, so that an animation of the viewpoint movement is displayed.

Furthermore, at this time, in the CG video 302, CG video 303, and CG video 304 as transition images, the viewpoint moves and the scale of the line or the goal represented by the wire frame can be changed. Therefore, it can be said that the transition image includes an image according to a change in the convergence angle of both eyes of the user.

FIG. 7 shows an example of an omnidirectional live action video after the viewpoint movement displayed on the head mounted display 31A. In FIG. 7, the head mounted display 31A displays an omnidirectional live action video 305 having a viewpoint according to the line-of-sight direction of the user viewing the omnidirectional live action video captured by the camera 41-2 behind the goal.

As described above, when the viewpoint is switched from the omnidirectional live action video 301 in the upper part of the stand (FIG. 3) to the omnidirectional live action video 305 behind the goal (FIG. 7), the animation of the viewpoint movement (the transition images in which the CG videos including the CG video 302 to the CG video 304 changes continuously) is displayed, so that the video is prevented from becoming monotonous, and the user can grasp how the viewpoint has changed.

Furthermore, when transition images in which the CG videos represented by the wire frame changes continuously are displayed as the display of an animation of the viewpoint movement, detailed information of the soccer stadium 2 is deformed, and therefore, motion sickness (so-called VR motion sickness) of the user using the head mounted display 31A can be reduced.

Note that although a case where CG videos represented by the wire frame are used as the animation of the viewpoint movement has been described, the representation by the wire frame is an example of an expression method for deforming an omnidirectional live action video, and another representation method may be used. Furthermore, in this specification, the term “deformation” has a meaning of simplifying a video and emphasizing features of the video.

(Flow of Reproduction and Display Control Processing)

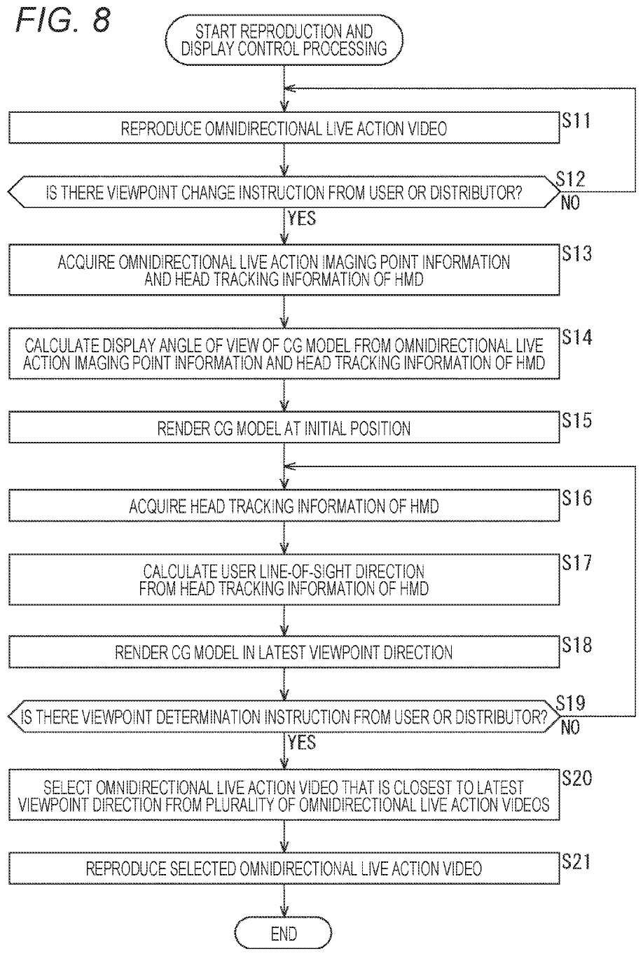

Next, a flow of a reproduction and display control processing performed by the UI and content control part 101 of the information processing apparatus 10 (FIG. 1) will be described with reference to a flowchart of FIG. 8.

Note that the information processing apparatus 10 including a game machine, a personal computer, and the like is connected to the head mounted display 31A as a premise that the processing shown in the flowchart of FIG. 8. Then, the user wearing the head mounted display 31A on the head operates a controller or the like while watching the screen displayed on the display to, such that the user can switch the viewpoint of the video displayed on the screen (omnidirectional live action video or CG video), for example.

In step S11, the UI and content control part 101 controls the reproduction part 102 to reproduce the omnidirectional live action video. Therefore, for example, the omnidirectional live action video 301 (FIG. 3) is displayed on the head mounted display 31A as the omnidirectional live action video in the upper part of the stand.

In step S12, the UI and content control part 101 determines whether or not there has been a viewpoint change instruction that is an instruction to change the viewpoint of a video from a user or a distributor, on the basis of an operation signal or the like input to the UI and content control part 101.

In a case where it is determined in step S12 that there is no viewpoint change instruction, the process returns to step S11, and the above-described process is repeated. In this case, for example, the display of the omnidirectional live action video 301 (FIG. 3) having a viewpoint according to the line-of-sight direction of the user viewing the omnidirectional live action video in the upper part of the stand is continued.

On the other hand, in step S12, for example, in a case where it is determined that the controller has been operated by the user and a viewpoint change instruction has been given, the process proceeds to step S13.

Note that, for a case where the viewpoint change instruction is given by the distributor, for example, when the content creator creates content in which the viewpoint is changed at a certain timing (for example, the switching time on the reproduction time axis of the omnidirectional live action video in the upper part of the stand), it is determined that the viewpoint change instruction has been given at the time when the timing (the switching time) is reached during the reproduction of the content.

In step S13, the UI and content control part 101 acquires the omnidirectional live action imaging point information and the head tracking information of the head mounted display 31A.

In step S14, the UI and content control part 101 calculates the display angle of view of the CG model read from the CG model data storage part 22 on the basis of the omnidirectional live action imaging point information and the head tracking information acquired in the processing of step S13.

In step S15, the UI and content control part 101 controls the rendering part 103 on the basis of the calculation result calculated in the processing of step S14, and renders the CG model at the initial position (the same position as the omnidirectional live action video). Therefore, for example, the CG video 302 (FIG. 4) corresponding to the viewpoint of the omnidirectional live action video 301 (FIG. 3) is displayed on the head mounted display 31A.

In step S16, the UI and content control part 101 acquires the head tracking information of the head mounted display 31A.

In step S17, the UI and content control part 101 calculates the line-of-sight direction of the user wearing the head mounted display 31A on the basis of the head tracking information acquired in the processing of step S16.

In step S18, the UI and content control part 101 controls the rendering part 103 on the basis of the calculation result calculated in the processing of step S17, and renders the CG model in the latest viewpoint direction. Therefore, for example, the CG video 303 (FIG. 5) is displayed on the head mounted display 31A.

In step S19, the UI and content control part 101 determines whether or not there has been a viewpoint determination instruction that is an instruction to determine the viewpoint of a video from a user or a distributor, on the basis of an operation signal or the like input to the UI and content control part 101.

In a case where it is determined in step S19 that there is no viewpoint determination instruction, the process returns to step S16, and the above-described process is repeated. That is, by repeating the processing of steps S16 to S18, for example, the CG video according to the user's line-of-sight (for example, a CG video represented by the wire frame) is displayed on the head mounted display 31A, next to the CG video 303 (FIG. 5).

On the other hand, in a case where it is determined in step S19 that a viewpoint determination instruction has been given, the process proceeds to step S20. In step S20, the UI and content control part 101 selects the omnidirectional live action video closest to the latest viewpoint direction from a plurality of omnidirectional live action videos.

Here, for example, in a case where a viewpoint determination instruction is given immediately after the CG video 304 (FIG. 6) is displayed, the omnidirectional live action video behind the goal corresponding to the viewpoint of the CG video 304 (FIG. 6) is selected as the omnidirectional live action video closest to the latest viewpoint direction.

In step S21, the UI and content control part 101 controls the reproduction part 102 to reproduce the omnidirectional live action video selected in the processing of step S20. For example, the omnidirectional live action video 305 (FIG. 7) having a viewpoint according to the line-of-sight direction of the user is displayed on the head mounted display 31A, as the omnidirectional live action video behind the goal. However, when displaying the omnidirectional live action video 305 (FIG. 7) behind the goal, the front direction thereof is determined so as to match the latest user's viewpoint direction before the display.

The flow of the reproduction and display control processing has been described above.

In this reproduction and display control processing, the display control part 112 of the UI and content control part 101 causes sequentially display of the CG video such as the CG video 302, the CG video 303, the CG video 304, for example, as the transition images that changes substantially continuously, when switching is made from the first video (for example, the omnidirectional live action video 301) that can be viewed from the first viewpoint (for example, a viewpoint corresponding to the upper part of the stand) to the second video (for example, the omnidirectional live action video 305) that can be viewed from the second viewpoint (for example, the viewpoint corresponding to the behind the goal).

The CG video (for example, the CG video 302, the CG video 303, the CG video 304, and the like) as the transition image is a deformed image of the video corresponding to the transition of a viewpoint from the first viewpoint (for example, the viewpoint corresponding to the upper part of the stand) to the second viewpoint (for example, the viewpoint corresponding to the behind the goal), and includes a background image having an information amount that is smaller than at least one of a background image of the first video (for example, the omnidirectional live action video 301) or a background image of the second video (for example, the omnidirectional live action video 305).

Here, the information amount is determined by, for example, image information including at least one of the color gradation or the resolution of the image. Then, the background image of the CG video (for example, the CG video 302, the CG video 303, the CG video 304, and the like) as the transition image includes an image represented by a predetermined single color such as black or blue, for example, as a background image having an information amount that is smaller than at least one of the background image of the first video or the background image of the second video.

Note that, here, a case where the transition image such as the CG video 302 includes an image represented by a predetermined single color as the background image is shown. However, for example, various images can be used as the transition image as long as the image includes a background image having an information amount that is smaller than at least one of the background image of the first video or the background image of the second video, such as an image obtained by reducing the resolution of the first video (for example, the omnidirectional live action video 301) and the second video (for example, the omnidirectional live action video 305).

### Example of Highlight Video Distribution

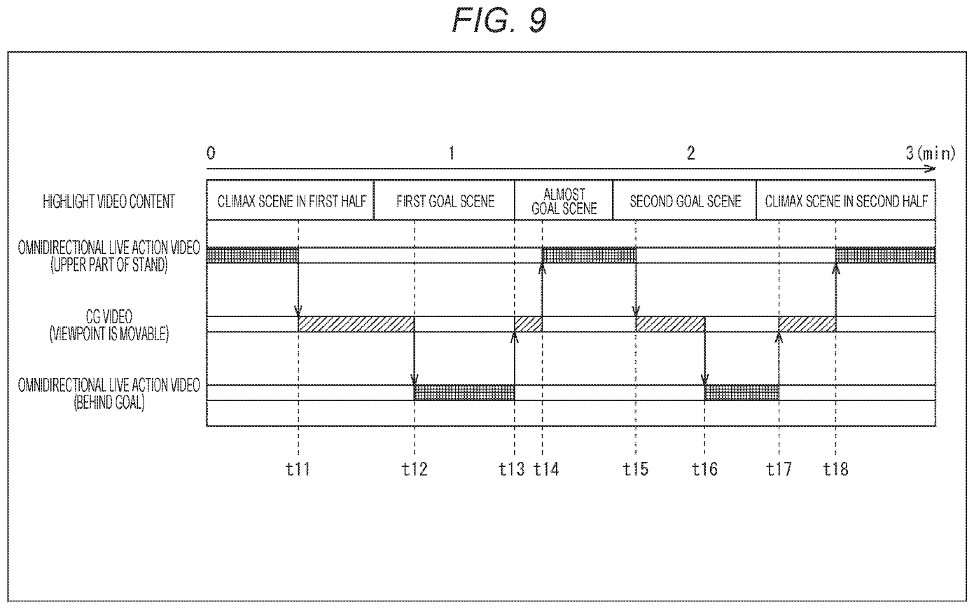

Next, as an example of video distribution incorporating the above-described CG video, an example of distribution of a highlight video in which only important scenes such as goal scenes are picked up in a soccer game will be described. FIG. 9 is a timing chart showing an example of highlight video distribution of soccer.

FIG. 9 represents which video is displayed in chronological order as the content of the highlight video, from the omnidirectional live action video in the upper part of the stand, the CG video of the animation of the viewpoint movement or the like, and the omnidirectional live action video behind the goal.

Note that the omnidirectional live action video in the upper part of the stand is captured by the camera 41-1 in FIG. 2, and the omnidirectional live action video behind the goal is captured by the camera 41-2 in FIG. 2.

In FIG. 9, the highlight video for three minutes includes a climax scene in the first half, a first goal scene, an almost goal scene, a second goal scene, and a climax scene in the second half. The user wearing the head mounted display 31A can switch the viewpoint of the omnidirectional live action video, and switch between the omnidirectional live action video and the CG video, for example, at his/her preferable timing by operating the controller or the like.

For example, a case is assumed where, in the head mounted display 31A, from the start time of the distribution of the highlight video, the omnidirectional live action video in the upper part of the stand is displayed as a climax scene in the first half, but the omnidirectional live action video is switched from the video in the upper part of the stand to the video behind the goal.

In this case, when the omnidirectional live action video 301 (FIG. 3) in the upper part of the stand is displayed at time t1, the CG videos 302 to 304 (FIGS. 4 to 6) are displayed at time t11 to time t12 as a viewpoint movement animation. Then, at time 12, the video is switched to the omnidirectional live action video 305 behind the goal (FIG. 7).

Therefore, from the middle of the first goal scene, the viewpoint is switched to the omnidirectional live action video behind the goal, and the user wearing the head mounted display 31A can view the first goal scene from the viewpoint of the side behind the goal.

After the end of the first goal scene, the viewpoint is returned from the omnidirectional live action video behind the goal to the omnidirectional live action video in the upper part of the stand. At this time, from time t13 to time t14, a CG video is displayed as the animation of the viewpoint movement, and at time t14, the video is switched to the omnidirectional live action video in the upper part of the stand.

Therefore, from the middle of the almost goal scene, the viewpoint is switched to the omnidirectional live action video in the upper part of the stand, and the user wearing the head mounted display 31A can view the almost goal scene from the viewpoint of the side in the upper part of the stand.

Following the almost goal scene is the second goal scene, but in the middle of the second goal scene, the viewpoint is switched again from the omnidirectional live action video in the upper part of the stand to the omnidirectional live action video behind the goal. At this time, from time t15 to time t16, a CG video is displayed as the animation of the viewpoint movement, and at time t16, the video is switched to the omnidirectional live action video behind the goal.

Therefore, from the middle of the second goal scene, the viewpoint is switched to the omnidirectional live action video behind the goal, and the user wearing the head mounted display 31A can view the second goal scene from the viewpoint of the side behind the goal as similar to the first goal.

Following the second goal scene is the climax scene in the second half. In the middle of the climax scene, the viewpoint is returned from the omnidirectional live action video behind the goal to the omnidirectional live action video in the upper part of the stand. At this time, from time t17 to time t18, a CG video is displayed as the animation of the viewpoint movement, and at time t18, the video is switched to the omnidirectional live action video in the upper part of the stand.

Therefore, from the middle of the climax scene in the second half, the viewpoint is switched to the omnidirectional live action video in the upper part of the stand, and the user wearing the head mounted display 31A can view the climax scene in the second half from the viewpoint of the side in the upper part of the stand. Then, when the climax scene in the second half ends, the distribution of the highlight video ends.

Note that, as the timing of switching between the omnidirectional live action video and the CG video, for example, the user wearing the head mounted display 31A can perform switching at preferable timing by operating a controller or the like when viewing the highlight video content, or, for example, the content creator (or the distributor) can perform switching at the intended timing (for example, the switching time on the reproduction time axis of the omnidirectional live action video) when creating the highlight video content.

Furthermore, when displaying a CG video, additional information related to the video may be displayed. For example, in a soccer game, various information (static or dynamic information) related to the player and the game, such as the name and position information of the player of interest (for example, the player who scored or assisted in the goal scene), the trajectory of the ball, or the ball dominance rate for each team can be displayed as additional information.

As described above, in the present technology, when switching the viewpoint from the first omnidirectional live action video captured by the first camera (for example, the first omnidirectional camera) to the second omnidirectional live action video captured by the second camera (for example, the second omnidirectional camera), the animation of the viewpoint movement including continuously changing CG videos is displayed, such that it is possible to avoid the inconvenient event accompanying the switching of the viewpoint of the video and improve user convenience.

For example, if switching from the first omnidirectional live action video to the second omnidirectional live action video is performed without any suggestion, the video becomes monotonous because the user cannot freely change the viewpoint, and the user may lose his or her direction and position. On the other hand, in the present technology, when switching the videos, displaying an animation of the viewpoint movement prevents the video from becoming monotonous by freely changing the viewpoint, and allows the user to grasp how the viewpoint has been changed.

Furthermore, for example, when switching from the first omnidirectional live action video to the second omnidirectional live action video, due to a sudden change in the video or a change in the video different from the motion of the body may cause motion sickness. In particular, in a case where the user wearing the head mounted display 31A performs an operation of switching viewpoints using a controller or the like, the possibility of getting motion sickness increases because the motion of the video is different from the actual motion of the body. In contrast, according to the present technology, at the time of switching between the videos, a deformed information is displayed by the CG video represented by the wire frame, for example, as the animation of the viewpoint movement, so that motion sickness (so-called VR motion sickness) of the user wearing the head mounted display 31A can be reduced.

Note that, in recent years, in sports broadcasts and the like, by 3D modeling of live action images using a large-scale camera system and video processing process, it is possible to view not only 2D videos but also 360-degree replay videos. However, in the present technology, it is possible to improve the degree of freedom of the effective viewpoint at low cost while utilizing existing equipment (for example, a game machine, a personal computer, or a head mounted display) by using an omnidirectional live action video captured by an existing equipment (for example, an omnidirectional camera).

Furthermore, in the present technology, by displaying a CG video, for example, it is possible to easily achieve an interactable expression such as a change in a viewpoint by a user operation or a display of additional information related to the live action video. Moreover, by reducing the difficulty in switching of the omnidirectional live action video or motion sickness, switching of the omnidirectional live action video is made easy, and it is possible to reduce monotonous of the omnidirectional live action video having a fixed viewpoint.

### 2. Second Embodiment

(Display Scale Change)

By the way, when displaying a CG video on the head mounted display 31A, the information processing apparatus 10 (the display control part 112 of the UI and content control part 101 thereof) can control the display so as to reduce the display scale to make the whole field look like a miniature. By displaying such a miniature CG video (so to speak, a reduced image), it is possible to intuitively change the viewpoint according to the motion of the user's head by making use of the features of the head mounted display 31A.

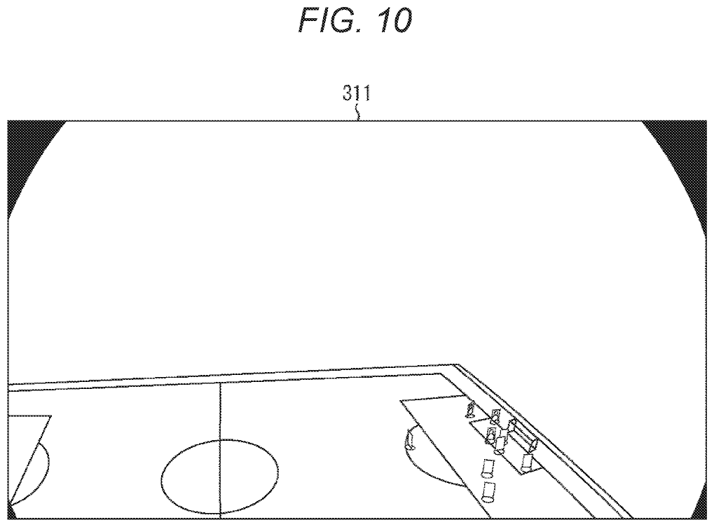

FIG. 10 shows a display example of a miniature CG video of a field on the head mounted display 31A.

In the miniature CG video 311 of FIG. 10, a field of the computer graphics (CG) is displayed in which the stand and the spectators are erased, and the entire is reduced in size, as compared to the omnidirectional live action video captured by the camera 41. Note that the miniature CG video 311 includes an image represented by a predetermined single color such as blue or black, for example, as a background image.

Furthermore, in the miniature CG video 311, the players on the field are represented not by the actual players themselves, but by the upper body of the players drawn on a plate-like panel. Since this player panel performs the similar motion to that of an actual player, the user wearing the head mounted display 31A can check the motion of the actual player by following the player panel moving around on the field.

Moreover, the viewpoint of the miniature CG video of this field is changed to, for example, the stand side or the side behind the goal in accordance with the motion of the head of the user wearing the head mounted display 31A. Therefore, by viewing from various angles (directions) or changing the distance from the CG field (for example, moving closer to or away from the CG field), players on the field or the like can be checked more reliably.

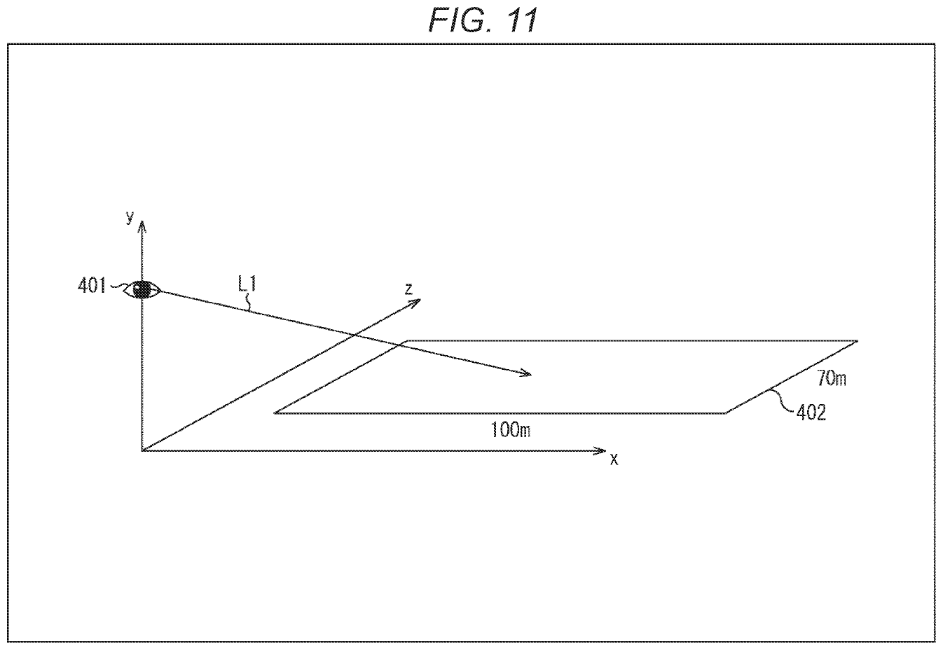

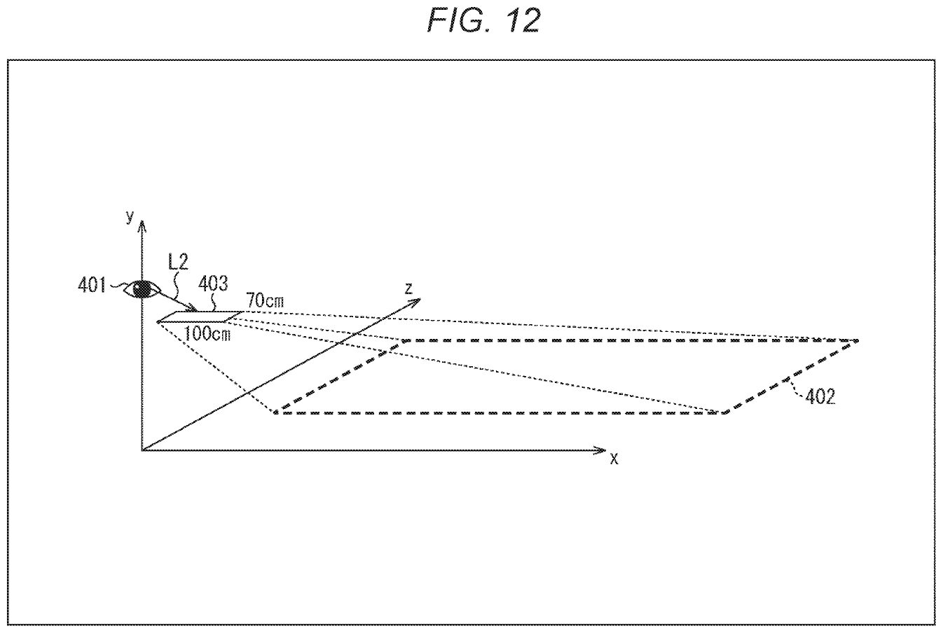

Here, with reference to FIG. 11 and FIG. 12, a method of changing the display scale at the time of transition from the omnidirectional live action video to the miniature CG video will be described.

FIG. 11 shows the distance to the field of the user's line-of-sight at the time of displaying the omnidirectional live action video in three dimensions using the xyz coordinate axes. In FIG. 11, the line-of-sight of a user 401 wearing the head mounted display 31A is directed to the vicinity of the center of the field 402 in the omnidirectional live action video, as indicated by the arrow in the drawing.

Here, for example, assuming a case where the touch line×the goal line is 100 m×70 m as the size of the field 402 in the omnidirectional live action video, the distance L1 to the vicinity of the center of the field 402 of the line-of-sight of the user 401 is 50 m.

On the other hand, FIG. 12 shows the distance to the field of the user's line-of-sight at the time of displaying the miniature CG video in three dimensions using the xyz coordinate axes. In FIG. 12, the line-of-sight of the user 401 wearing the head mounted display 31A is directed to the vicinity of the center of the field 403 in the miniature CG video, as indicated by the arrow in the drawing.

Here, in FIG. 12, the field 402 of the omnidirectional live action video shown in FIG. 11 is indicated by a dotted line in the drawing, so that its size can be compared with the size of the field 403 of the miniature CG video.

For example, assuming the case where the touch line×the goal line is 100 cm×70 cm as the size of the field 403 in the miniature CG video is 100 cm×70 cm, the size of the field 403 is 1/100 of the size of the field 402 which is 100 m×70 m. That is, when a transition is made from the omnidirectional live action video to the miniature CG video, the size of the field is reduced to 1/100 (the size is changed from the actual size to the miniature size).

Then, when the field 403 in the miniature CG video is 1/100 size, that is, 100 cm×70 cm, the distance L2 of the line-of-sight of the user 401 wearing the head mounted display 31A to the vicinity of the center of the field 403 is 50 cm, and is the length of 1/100 of the line-of-sight distance L1 (50 m) in the case of the omnidirectional live action video shown in FIG. 11. That is, when a transition is made from the omnidirectional live action video to the miniature CG video, the position of the field is brought closer to the viewpoint direction in accordance with a change in the size (display scale) of the field.

As described above, according to the present technology, when a transition is made from the omnidirectional live action video to the miniature CG video and changing the size of the field from the actual size to the miniature size, the position of the field is also changed in the viewpoint direction of the user in accordance with a change in the size. As a result, the size can be continuously changed without changing the angle of view viewed by the user wearing the head mounted display 31A.

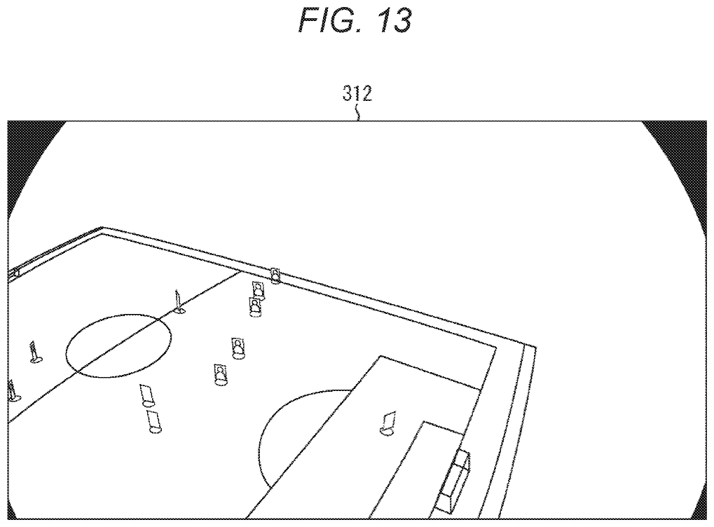

As the miniature CG video displayed in this way, for example, the CG videos as shown in FIGS. 13 to 15 can be displayed. That is, in FIG. 13 to FIG. 15, a series of flows until a score is obtained in a goal scene in a soccer game played in the soccer stadium 2 is represented by a miniature CG video.

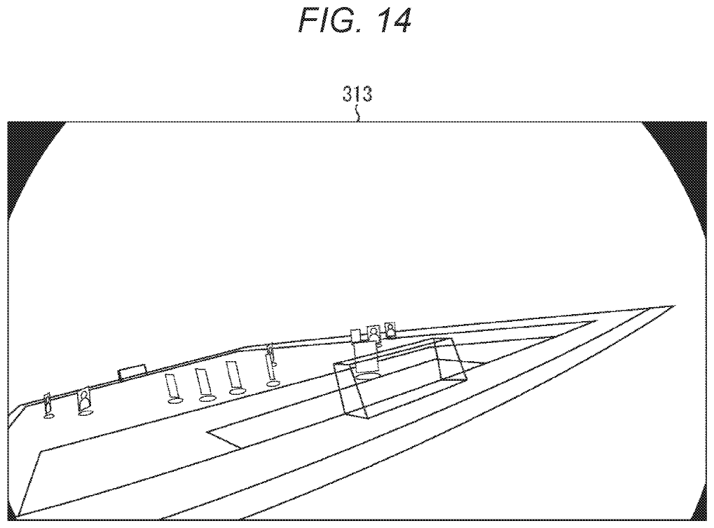

Specifically, the miniature CG video 312 in FIG. 13 represents a situation where a player of the offending team holding the ball is about to launch an attack near the halfway line. Thereafter, the miniature CG video 313 of FIG. 14 represents a situation where the players of the attacking team are approaching the vicinity of the penalty area, and the players of the defending team are dealing with it.

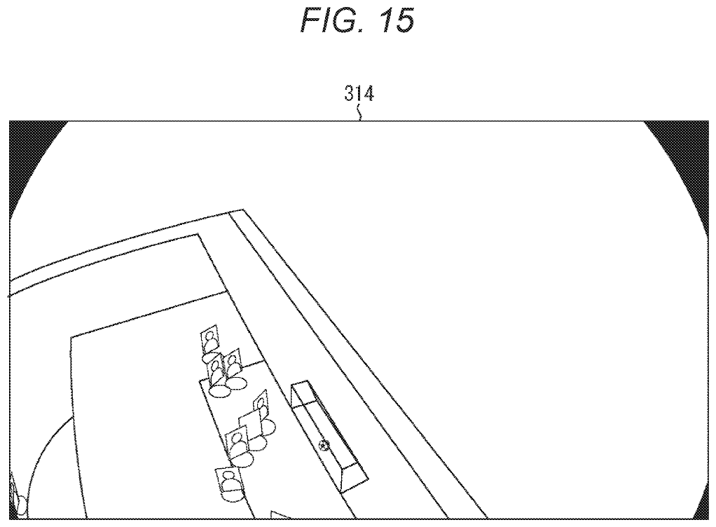

Then, the miniature CG video 314 of FIG. 15 represents the situation where the player of the defending team cannot parry the ball shot by the player of the offending team who entered the penalty area, the ball enters the goal, and the offending team scored the goal.

Here, in a series of flows until a goal is scored in the goal scene shown in FIGS. 13 to 15, the viewpoint of the CG video displayed on the display changes according to the motion of the head of the user wearing the head mounted display 31A.

For example, the miniature CG video 312 in FIG. 13 is a CG video viewed from the stand side, while the miniature CG video 313 in FIG. 14 is a CG video viewed from back side of the goal. Furthermore, for example, the miniature CG video 312 in FIG. 13 is a CG video zoomed out to view the entire field, while the miniature CG video 314 in FIG. 15 is a CG video zoomed in a player near the ball.

As described above, by applying the present technology, it is possible to look over the field from various angles by changing the viewpoint of the miniature CG video according to the motion of the head of the user wearing the head mounted display 31A.

For example, there are various demands in the user watching the content of a soccer game, and some users want to look down on the entire field, some want to watch a player closer, some want to watch the game from the stand side, or some want to watch the game from back side of the goal. However, by applying the present technology, it is possible to look over the field from various angles, so that the demands can be met.

Note that, for the timing of displaying this miniature CG video, for example, as shown in the timing chart of FIG. 9, when viewing the highlight video content, by switching the display of the omnidirectional live action video in the upper part of the stand or behind the goal, it is possible to display a miniature CG video as a CG video having movable viewpoint. By displaying this miniature CG video, for example, it is possible to check the position of the player of interest or the ball, or to check an important scene such as a goal scene.

Furthermore, as the timing of switching between the omnidirectional live action video and the miniature CG video, for example, the user wearing the head mounted display 31A can perform switching at preferable timing by operating a controller or the like when viewing the highlight video content, or, for example, the content creator can perform switching at the intended timing when creating the highlight video content.

Moreover, when displaying a miniature CG video, for example, various pieces of information related to players and games, such as the name and position information of the player of interest, the trajectory of the ball, and the ball domination rate for each team can be displayed as additional information.

### 3. Third Embodiment

(Display Scale Change)

In the above description, an example in which the entire field of a soccer stadium is made to look like a miniature by using a miniature CG video on the head mounted display 31A has been described, but this miniature CG video can be used in not only the field of a soccer stadium but in various situations.

For example, on the head mounted display 31A, a miniature CG video of the arrangement of musical instruments in the orchestra can be displayed when displaying an omnidirectional live action video of the orchestra performed in the concert hall.

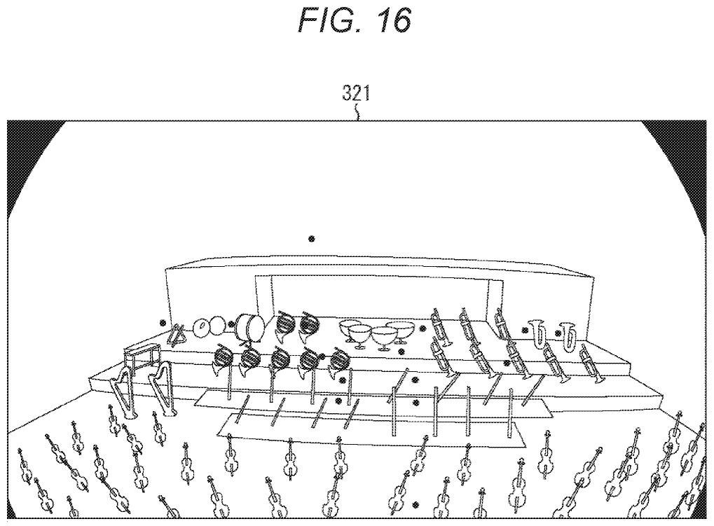

FIG. 16 shows a display example of miniature CG of the arrangement of musical instruments in the orchestra on the head mounted display 31A.

Note that, although the detailed description will be omitted since it is redundant, one or more cameras (for example, omnidirectional cameras) are installed in the concert hall where the orchestra is performed, and, for example, an omnidirectional live action video according to the installation position such as the vicinity of the conductor on the stage or the audience seat is captured.

For example, in the head mounted display 31A, when the display is switched from the omnidirectional live action video captured by a camera installed in a concert hall to a miniature CG video, the miniature CG video 321 in FIG. 16 is displayed.

In the miniature CG video 321 of FIG. 16, CG musical instruments arranged corresponding to the actual musical instrument arrangement are displayed on the CG stage whose entire size is reduced. Furthermore, in the miniature CG video 321, only musical instruments are represented by CG, and the player are not converted to CG.

Since the CG musical instruments are arranged corresponding to the actual musical instrument arrangement of the orchestra, the user wearing the head mounted display 31A can check the musical instrument arrangement of the orchestra in the concert hall.

For example, in the miniature CG video 321, string instruments such as violin and viola are arranged in the front part of the stage, and woodwind instruments such as flute and oboe are arranged behind those string instruments. Furthermore, in the miniature CG video 321, brass instruments such as trumpets and trombone are arranged behind those woodwind instruments, and percussion instruments are arranged behind those brass instruments or rear part of the stage.

Note that, in FIG. 16, only the miniature CG video is displayed on the head mounted display 31A, but together with the miniature CG video, an omnidirectional live action video captured by a camera installed in a concert hall may be displayed at the same time, as a background image of the miniature CG video. For example, by displaying the miniature CG video 321 with superimposed on the omnidirectional live action video, the user can check the musical instrument arrangement of the orchestra while watching the actual orchestra performance.

Furthermore, the background image of the miniature CG video may include, for example, an image obtained by reducing the resolution of an omnidirectional live action video, an image represented by a predetermined single color such as blue or black, and the like.

Furthermore, the viewpoint of the miniature CG video of this musical instrument arrangement of the orchestra is changed in accordance with the motion of the head of the user wearing the head mounted display 31A. Therefore, by viewing from various angles (directions) or changing the distance from the CG stage (for example, moving closer to or away from the CG stage), the musical instrument arrangement can be checked more reliably.

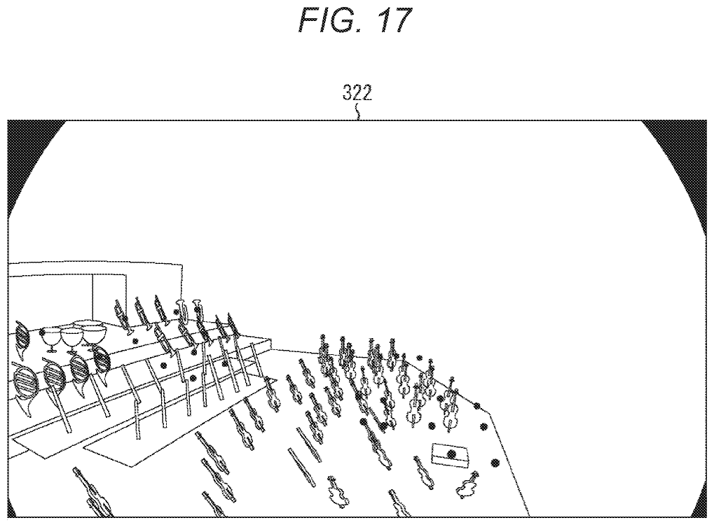

For example, the miniature CG video 321 in FIG. 16 is a CG video when the entire stage is viewed from almost the front, while in FIG. 17, the miniature CG video 322 is a CG video when the entire stage is viewed from the upper left.

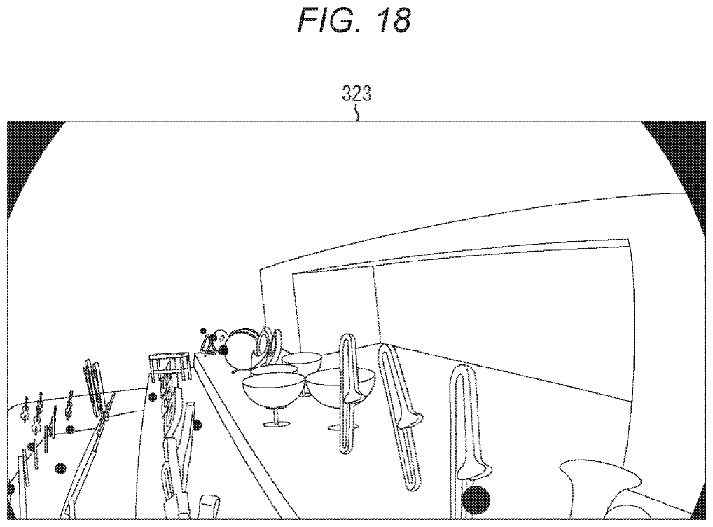

Furthermore, for example, the miniature CG video 321 in FIG. 16 and the miniature CG video 322 in FIG. 17 are CG videos in which a certain distance from the stage is maintained, while in FIG. 18, the miniature CG video 323 is a CG video closer to the brass and percussion instruments arranged rear part of the stage.

As described above, by applying the present technology, it is possible to look over the stage on which musical instruments are arranged from various angles by changing the viewpoint of the miniature CG video according to the motion of the head of the user wearing the head mounted display 31A.

For example, there are various demands in the user watching the content of an orchestra concert, and some users want to check the musical instrument arrangement of the orchestra in the concert hall, some want to look down on the entire musical instrument arrangement, some want see it closer, some want to see it from the front of the stage, or some want to see it from the side of the stage. However, by applying the present technology, it is possible to look over the stage on which musical instruments are arranged from various angles, so that the demands can be met.

Note that, as the timing of switching between the omnidirectional live action video and the miniature CG video, for example, the user wearing the head mounted display 31A can perform switching at preferable timing when viewing the orchestra concert content by operating a controller or the like, or, for example, the content creator can perform switching at the intended timing when creating the orchestra concert content.

Furthermore, when displaying a miniature CG video, for example, various pieces of information related to players and musical instruments, such as the name of the player of interest, and the name of the musical instrument can be displayed as additional information.

Moreover, although the description is omitted here, as similar to the above-described example of soccer stadium, when switching the omnidirectional live action video captured by the camera installed in the concert hall where the orchestra is performed, an animation of the viewpoint movement by the CG video that changes continuously may be displayed. Therefore, it is possible to avoid inconvenience caused by switching the viewpoint of the video, and to improve the convenience for the user.

### 4. Fourth Embodiment

In the above description, as an example of video distribution incorporating CG video, an example of soccer highlight video distribution has been described. However, the video distribution incorporating the CG video is not limited to soccer highlight video, and can be used in various video distribution.

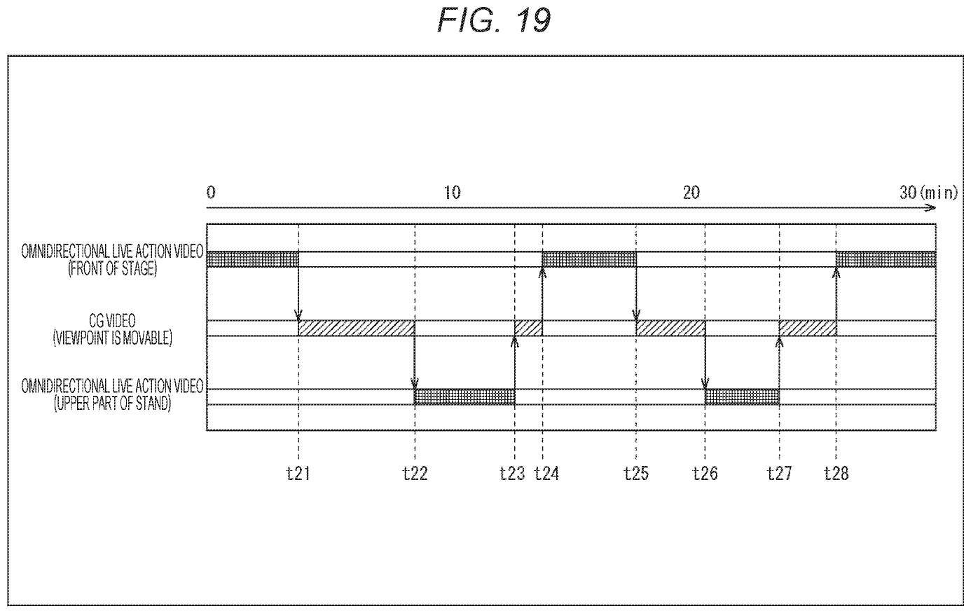

For example, on the head mounted display 31A, various CG videos can be displayed when displaying an omnidirectional live action video of live music. FIG. 19 shows a timing chart showing an example of music live video distribution.

FIG. 19 represents, in chronological order, which video of the omnidirectional live action video in the front part of the stage, the CG video having a movable viewpoint, and the omnidirectional live action video in the upper part of the stand is displayed as a music live video.

Note that although the detailed description will be omitted since it is redundant, one or a plurality of cameras (for example, omnidirectional cameras) is installed at a venue where a music live event is performed. For example, at the event venue, an omnidirectional camera installed in the front part of the stage captures an omnidirectional live action video in the front part of the stage, and an omnidirectional camera installed in the upper part of the stand captures an omnidirectional live action video in the upper part of the stand.

An omnidirectional live action video in the front part of the stage is displayed on the head mounted display 31A from the distribution start time of the music live video for 30 minutes.

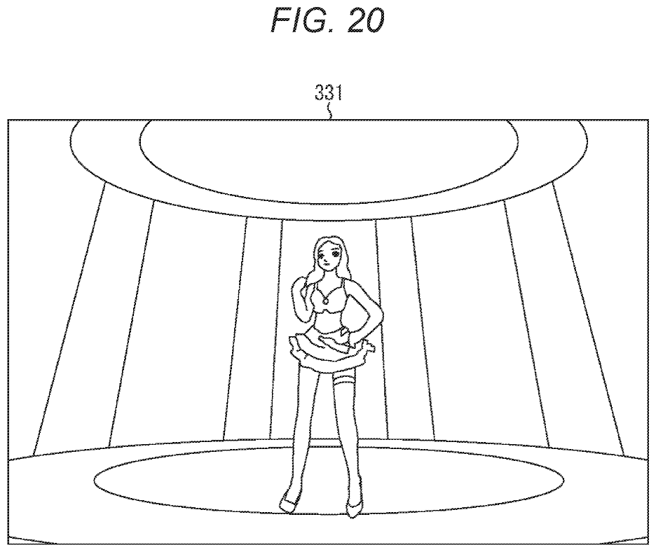

FIG. 20 shows an example of an omnidirectional live action video in the front part of the stage displayed on the head mounted display 31A. In FIG. 20, the head mounted display 31A displays an omnidirectional live action video 331 having a viewpoint according to the line-of-sight direction of the user viewing the omnidirectional live action video captured in the front part of the stage.

The user wearing the head mounted display 31A can switch the viewpoint of the omnidirectional live action video, and switch between the omnidirectional live action video and the CG video, for example, at his/her preferable timing by operating the controller or the like.

In this example, at time t21, the omnidirectional live action video in the front part of the stage is switched to the CG video. Moreover, at time t22, the CG video is switched to the omnidirectional live action video in the upper part of the stand. Here, various CG videos can be displayed as the CG videos displayed between time t21 and time t22. For example, the following display is performed.

That is, between the time t21 and the time t22, it is possible to produce a stage that is not realistic with the CG video, in addition to the omnidirectional live action video with a realistic feeling from a plurality of viewpoints.

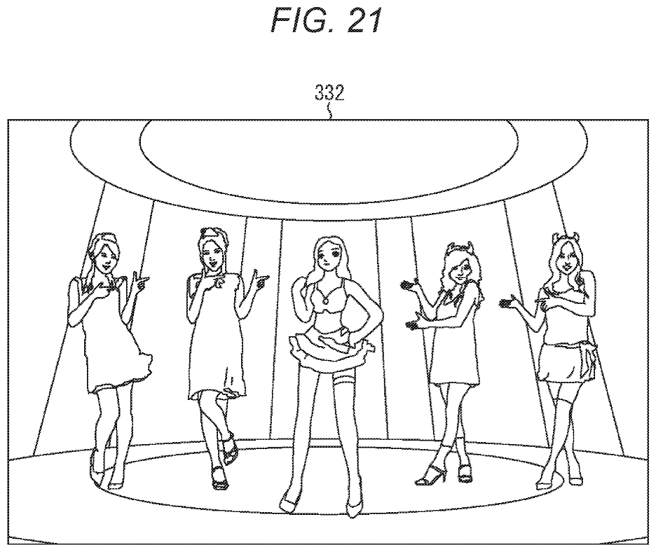

FIG. 21 shows an example of a video displayed on the head mounted display 31A in which an unrealistic stage effect has been exhibited. In a CG synthesized video 332 of FIG. 21, the head mounted display 31A displays two female back dancers on the left and right sides of the female singer in the center, which is an omnidirectional live action video in the front part of the stage, in CG video (synthesized display). In the CG synthesized video 332 in FIG. 21, four back dancers (CG artists) move in synchronization with a female singer (live action artist) whose motion is captured.

Note that, here, an example is shown in which another artist (back dancer) is displayed as an effect that does not exist in real by CG videos, but for example, various effects can be performed, such as display of an object that is not on the stage, or a lighting effect.

Furthermore, as described above, assuming a case where the omnidirectional live action video is switched from the front part of the stage to the upper part of the stand, a CG video (for example, the CG video in an event venue represented by wire frame) as an animation of the viewpoint movement may be displayed at the time between time t21 and time t22. Therefore, it is possible to prevent the video from becoming monotonous and to allow the user to grasp how the viewpoint has changed.

Furthermore, the above-described miniature CG video may be displayed between time t21 and time t22. As the miniature CG video here, various CG videos can be displayed. For example, as similar to the second embodiment, the arrangement of musical instruments (for example, guitars, drums, and the like) that perform in a music live can be shown. Therefore, it is possible to look over the stage from various angles by changing the viewpoint of the miniature CG video according to the motion of the head of the user wearing the head mounted display 31A.

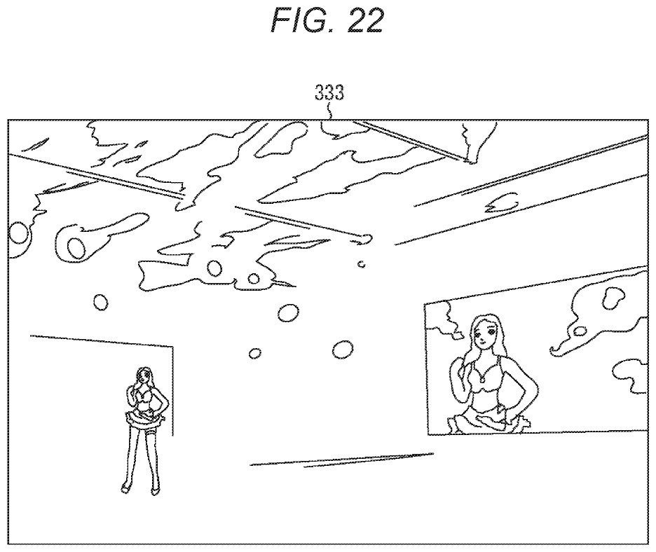

Then, at time t22, the display is switched to the omnidirectional live action video in the upper part of the stand. FIG. 22 shows an example of an omnidirectional live action video in the upper part of the stand, which is displayed on the head mounted display 31A. In FIG. 22, the head mounted display 31A displays an omnidirectional live action video 333 having a viewpoint according to the line-of-sight direction of the user viewing the omnidirectional live action video in the upper part of the stand.

Thereafter, at time t23, the video is switched to the CG video, and moreover, at time t24, the video is switched to the omnidirectional live action video in the front part of the stage. Furthermore, at time t25, the video is switched to the CG video, and moreover, at time t26, the video is switched to the omnidirectional live action video in the front part of the stand. Furthermore, at time t27, the video is switched to the CG video, and moreover, at time t28, the video is switched to the omnidirectional live action video in the front part of the stage. Note that the display content of these omnidirectional live action videos and CG videos are similar to those described above, and thus a description thereof will be omitted.

As described above, by applying the present technology, for a user wearing the head mounted display 31A, for example, it is possible to produce a stage that is not realistic or the animation of the viewpoint movement with the CG video, in addition to the omnidirectional live action video.

Note that, as the timing of switching between the omnidirectional live action video and the CG video, for example, the user wearing the head mounted display 31A can perform switching at preferable timing by operating a controller or the like when viewing the music live content, or the content creator can perform switching at the intended timing when creating the music live content.

Furthermore, when displaying a CG video, for example, various pieces of information related to artists and musical instruments, such as the name of the artist of interest and the name of the musical instrument can be displayed as additional information.

### 5. Modification

(Other Usage Examples)

In the above description, the case where the CG video to which the present technology is applied is displayed for an omnidirectional live action video of a soccer game, an orchestra concert, and a music live is shown. However, the present invention is applicable to various other cases.

For example, it is assumed that, in a case of providing a sightseeing experience or sightseeing guide, a high-quality omnidirectional live action video (moving image or live video) captured by a camera (for example, an omnidirectional camera) installed at a sightseeing spot is viewed by the head mounted display 31A.

In this case, for example, when switching between omnidirectional live action video, inserting an animation of the viewpoint movement by the CG video, or displaying a miniature CG video enables the user wearing the head mounted display 31A to feel the topography of the sightseeing spot, the overall city, the distance, and the like.

Note that, the use data of the examples of the sightseeing experience and the sightseeing guide can include, for example, as the omnidirectional live action video, a general route video of a sightseeing spot (including indoor and outdoor videos) and high-quality moving images, live videos, images, and the like of a specific spot of a sightseeing spot. Furthermore, for example, a simple CG model of the entire sightseeing spot can be included for use as a CG video.

Furthermore, for example, it is assumed that, in a case of providing a security system, an omnidirectional live action video (live video) captured by a camera (for example, an omnidirectional camera) installed at a security target facility is monitored by the display device 31 (for example, the head mounted display 31A).

In this case, for example, at the time of switching the omnidirectional live action video, the following effects can be obtained by inserting an animation of the viewpoint movement by the CG video or displaying the miniature CG video. That is, with display of the animation of the viewpoint movement, for example, when switching the camera from one room to a different room, a guard can intuitively recognize the motion between the rooms.

Furthermore, by using the omnidirectional live action video captured by a camera (for example, an omnidirectional camera) installed in the facility, even if something unusual such as alert sounding occurs, the guard can check the security target in the same way without going to the location. Moreover, by making the omnidirectional live action video to have a high-quality and high-quality sound, it becomes easier for the security guard to notice a slight change in the security target.

Note that, the use data of the example of the security system includes, for example, a live video of a security target with high image quality and high sound quality as an omnidirectional live action video. Furthermore, for example, a CG model of a part other than a room can be included for use as a CG video. Moreover, here, live videos of sensor data obtained by various sensors, CG models thereof, and the like may be used.

(Configuration Example of Electronic Device)

In the above description, in the video reproduction system 1, the information processing apparatus 10 controls the video displayed on the display device 31 such as the head mounted display 31A, but the display device 31 may have a function of reproducing and rendering the video.

For example, the head mounted display 31A may have the functions of the UI and content control part 101, the reproduction part 102, and the rendering part 103 shown in FIG. 1. In other words, in the video reproduction system 1, it can be said that the information processing apparatus 10 and the display device 31 can be integrally configured as one device.

Furthermore, the information processing apparatus 10 can be applied to, in addition to the game machine, the personal computer, and the like described above, for example, a smartphone or tablet-type computer, a television receiver, a reproducing device, a recorder, a set top box (STB), or an electronic device capable of reproducing content such as a storage device. Furthermore, the display device 31 can be applied to, in addition to the above-described head mounted display and smartphone, for example, an electronic device having a display such as a wearable computer such as a glasses-type information terminal, a tablet-type computer, a personal computer, and a game machine.

(Other Examples of CG Videos)

In the above description, a virtual reality that enables a user wearing the head mounted display 31A to experience a feeling as if he/she was there by displaying an omnidirectional live action video is achieved. However, the present technology is not limited to virtual reality (VR), and may be applied to augmented reality (AR) that extends the real world by displaying additional information in a real space, and the like.

For example, when a user taking a seat in a concert hall views an orchestra on a stage via a display of a smartphone that has activated a dedicated application, the display can display a video in which a miniature CG video of the musical instrument arrangement of the orchestra is superimposed on the video of the orchestra in real space.

Note that the omnidirectional live action video is not limited to a video captured by an omnidirectional camera fixed at the installation position in a certain facility, and, for example, an omnidirectional live action video captured by various methods, such as an omnidirectional live action video captured by aerial photography with an omnidirectional camera equipped with an unmanned aerial vehicle (UAV) can be used. Furthermore, in the above description, the omnidirectional live action video captured by the camera 41 is described. However, the present technology can be applied to various videos such as a video captured by a camera such as a semi-spherical camera, for example.

### 6. Computer Configuration

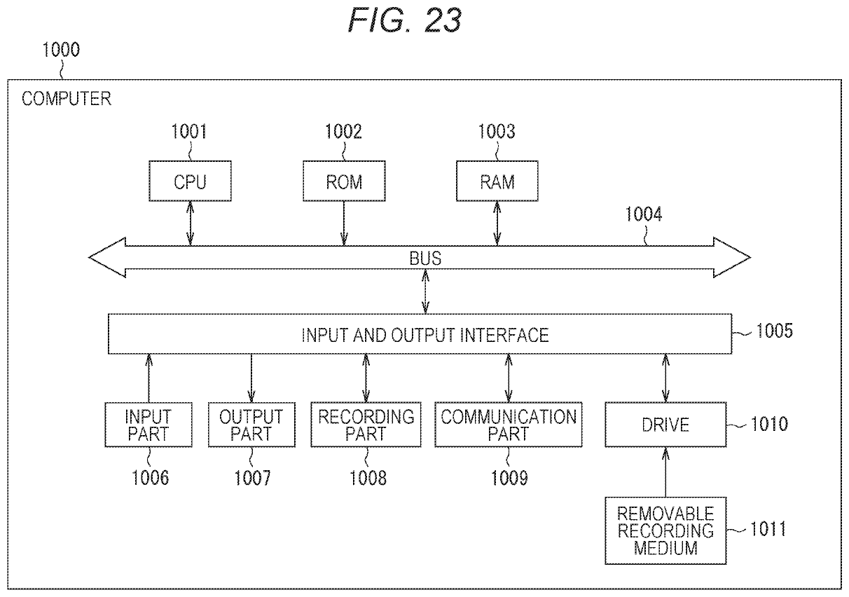

The series of processing (for example, the reproduction and display control processing shown in FIG. 8) described above can be also executed by hardware or can be executed by software. In a case where a series of processing is executed by software, a program constituting the software is installed in a computer of each device. FIG. 23 is a block diagram showing a configuration example of a hardware of a computer that executes the above-described series of processing by a program.

In a computer 1000, a central processing unit (CPU) 1001, a read only memory (ROM) 1002, and a random access memory (RAM) 1003 are mutually connected by a bus 1004. An input and output interface 1005 is further connected to the bus 1004. An input part 1006, an output part 1007, a recording part 1008, a communication part 1009, and a drive 1010 are connected to the input and output interface 1005.

The input part 1006 includes a keyboard, a mouse, a microphone, and the like. The output part 1007 includes a display, a speaker, and the like. The recording part 1008 includes a hard disk, a nonvolatile memory, and the like. The communication part 1009 includes a network interface and the like. The drive 1010 drives a removable recording medium 1011 such as a magnetic disk, an optical disk, a magneto-optical disk, or a semiconductor memory.

In the computer 1000 configured as described above, the CPU 1001 loads the program recorded in the ROM 1002 or the recording part 1008 into the RAM 1003 via the input and output interface 1005 and the bus 1004, and executes the program, so that the above-described series of processing is performed.

The program executed by the computer 1000 (CPU 1001) can be provided by being recorded on the recording medium 1011 as a package medium or the like, for example. Furthermore, the program can be provided via a wired or wireless transmission medium such as a local area network, the Internet, or digital satellite broadcasting.

In the computer 1000, a program can be installed in the recording part 1008 via the input and output interface 1005 by mounting the recording medium 1011 to the drive 1010. Furthermore, the program can be received by the communication part 1009 via a wired or wireless transmission medium and installed in the recording part 1008. In addition, the program can be installed in the ROM 1002 or the recording part 1008 in advance.

Here, in the present specification, processing performed by a computer according to a program does not necessarily need to be performed in a time series in the order described in the flowchart. That is, the processing performed by the computer according to the program also includes processing executed in parallel or individually (for example, parallel processing or processing by an object). Furthermore, the program may be processed by one computer (processor) or processed by a plurality of computers in a distributed manner.

Note that the embodiments of the present technology are not limited to the above-described embodiments, and various modifications are possible without departing from the gist of the present technology. For example, in the present technology, it is possible to adopt a configuration of cloud computing in which one function is shared by a plurality of devices via a network, and is collaboratively processed.

Furthermore, each step of the reproduction and display control processing shown in FIG. 8 can be executed by one device or shared and executed by a plurality of devices. Moreover, in a case where a plurality of processes is included in one step, a plurality of processes included in the one step can be executed by one device or shared and executed by a plurality of devices.

Note that, the present technology can also adopt the following configuration.

(1)

An information processing apparatus including
a display control part that controls a display device to display a transition image that changes substantially continuously and includes a background image having an information amount that is smaller than at least one of a background image of a first video or a background image of a second video, when switching from the first video viewable from a first viewpoint to the second video viewable from a second viewpoint different from the first viewpoint.

(2)

The information processing apparatus according to (1) described above,
in which the transition image includes an image obtained by simplifying a video corresponding to transition of a viewpoint from the first viewpoint to the second viewpoint and emphasizing features of the video.

(3)

The information processing apparatus according to (2) described above,
in which, in the transition image, a first transition image to be displayed at a start of switching includes an image obtained by simplifying the first video and emphasizing features of the first video, and a second transition image to be displayed at an end of switching includes an image obtained by simplifying the second video and emphasizing features of the second video.

(4)

The information processing apparatus according to any one of (1) to (3) described above,
in which the transition image is a computer graphics (CG) video.

(5)

The information processing apparatus according to (4) described above,
in which the CG video is a video represented by wire frame.

(6)

The information processing apparatus according to (5) described above,
in which the first transition image includes an image in which a target object included in the first video is represented only by an outline, and
the second transition image includes an image in which a target object included in the second video is represented only by an outline.

(7)

The information processing apparatus according to any one of (1) to (6) described above,
in which the information amount is determined by image information including at least one of a color gradation or a resolution of an image.

(8)

The information processing apparatus according to (7) described above,
in which the transition image includes, as the background image, an image represented by a predetermined single color, or an image obtained by reducing a resolution of the first video or the second video.

(9)

The information processing apparatus according to any one of (1) to (8) described above,
in which the transition image includes an image according to a change in a convergence angle of both eyes of a user.

(10)

The information processing apparatus according to any one of (1) to (9) described above,
in which switching is made from the first video to the second video on the basis of a user operation or a switching time on a reproduction time axis of the first video.

(11)

The information processing apparatus according to any one of (1) to (10) described above,
in which the display control part controls display of a reduced image obtained by reducing a target object included in the first video or the second video.

(12)

The information processing apparatus according to (11) described above,
in which the reduced image is a CG video.

(13)

The information processing apparatus according to (11) or (12) described above,
in which the display control part, when switching from the first video or the second video to the reduced image, brings a position of the target object included in the first video or in the second video closer to a viewpoint direction of the user according to a change in a display scale of the target object.

(14)

The information processing apparatus according to (12) or (13) described above,
in which the display control part includes, as the reduced image, a CG video according to a motion of a person included in the first video or the second video.

(15)

The information processing apparatus according to (12) or (13) described above,
in which the display control part includes, as the reduced image, a CG video according to an arrangement of an object included in the first video or the second video.

(16)

The information processing apparatus according to any one of (1) to (15) described above,
in which each of the first video and the second video is an omnidirectional live action video.

(17)

The information processing apparatus according to (16) described above,
in which the camera that captures the omnidirectional live action video is installed in a stadium where a competition including sports is performed, a building where an event including a music concert is performed, inside a structure, or outdoors, and
the omnidirectional live action video includes a video of a competition including sports, a video of an event including a music concert, a video of an inside of a structure, or a video of an outdoor.

(18)

The information processing apparatus according to any one of (1) to (17) described above,
in which the display device is a head mounted display.

(19)

An information processing method of an information processing apparatus,
in which the information processing apparatus
controls a display device to display a transition image that changes substantially continuously and includes a background image having an information amount that is smaller than at least one of a background image of a first video or a background image of a second video, when switching from the first video viewable from a first viewpoint to the second video viewable from a second viewpoint different from the first viewpoint.

(20)

A program for causing a computer to function as
a display control part that controls a display device to display a transition image that changes substantially continuously and includes a background image having an information amount that is smaller than at least one of a background image of a first video or a background image of a second video, when switching from the first video viewable from a first viewpoint to the second video viewable from a second viewpoint different from the first viewpoint.

### REFERENCE SIGNS LIST

1 Video reproduction system
10 Information processing apparatus
21 Video and CG control data storage part
22 CG model data storage part
31 Display device
31A Head mounted display
32 Speaker
41, 41-1, 41-2 Camera
101 UI and content control part
102 Reproduction part
103 Rendering part
111 Reproduction control part
112 Display control part
121 Data acquisition part
122 Demux
123 First video decoder
124 Second video decoder
125 Audio decoder
126 CG control data decoder
127 Synchronization control part
1000 Computer
1001 CPU

1. An information processing apparatus comprising
a display control part that controls a display device to display a transition image that changes substantially continuously and includes a background image having an information amount that is smaller than at least one of a background image of a first video or a background image of a second video, when switching from the first video viewable from a first viewpoint to the second video viewable from a second viewpoint different from the first viewpoint.

2. The information processing apparatus according to claim 1,
wherein the transition image includes an image obtained by simplifying a video corresponding to transition of a viewpoint from the first viewpoint to the second viewpoint and emphasizing features of the video.

3. The information processing apparatus according to claim 2,
wherein, in the transition image, a first transition image to be displayed at a start of switching includes an image obtained by simplifying the first video and emphasizing features of the first video, and a second transition image to be displayed at an end of switching includes an image obtained by simplifying the second video and emphasizing features of the second video.

4. The information processing apparatus according to claim 3,
wherein the transition image is a computer graphics (CG) video.

5. The information processing apparatus according to claim 4,
wherein the CG video is a video represented by wire frame.

6. The information processing apparatus according to claim 5,
wherein the first transition image includes an image in which a target object included in the first video is represented only by an outline, and
the second transition image includes an image in which a target object included in the second video is represented only by an outline.

7. The information processing apparatus according to claim 1,
wherein the information amount is determined by image information including at least one of a color gradation or a resolution of an image.

8. The information processing apparatus according to claim 7,
wherein the transition image includes, as the background image, an image represented by a predetermined single color, or an image obtained by reducing a resolution of the first video or the second video.

9. The information processing apparatus according to claim 2,
wherein the transition image includes an image according to a change in a convergence angle of both eyes of a user.

10. The information processing apparatus according to claim 1,
wherein switching is made from the first video to the second video on a basis of a user operation or a switching time on a reproduction time axis of the first video.

11. The information processing apparatus according to claim 1,
wherein the display control part controls display of a reduced image obtained by reducing a target object included in the first video or the second video.

12. The information processing apparatus according to claim 11,
wherein the reduced image is a CG video.

13. The information processing apparatus according to claim 12,
wherein the display control part, when switching from the first video or the second video to the reduced image, brings a position of the target object included in the first video or the second video closer to a viewpoint direction of the user according to a change in a display scale of the target object.

14. The information processing apparatus according to claim 13,
wherein the display control part includes, as the reduced image, a CG video according to a motion of a person included in the first video or the second video.

15. The information processing apparatus according to claim 13,
wherein the display control part includes, as the reduced image, a CG video according to an arrangement of an object included in the first video or the second video.

16. The information processing apparatus according to claim 1,
wherein each of the first video and the second video is an omnidirectional live action video.

17. The information processing apparatus according to claim 16,
wherein a camera that captures the omnidirectional live action video is installed in a stadium where a competition including sports is performed, a building where an event including a music concert is performed, inside a structure, or outdoors, and
the omnidirectional live action video includes a video of a competition including sports, a video of an event including a music concert, a video of an inside of a structure, or a video of an outdoor.

18. The information processing apparatus according to claim 1,
wherein the display device is a head mounted display.

19. An information processing method of an information processing apparatus,
wherein the information processing apparatus
controls a display device to display a transition image that changes substantially continuously and includes a background image having an information amount that is smaller than at least one of a background image of a first video or a background image of a second video, when switching from the first video viewable from a first viewpoint to the second video viewable from a second viewpoint different from the first viewpoint.

20. A program for causing a computer to function as
a display control part that controls a display device to display a transition image that changes substantially continuously and includes a background image having an information amount that is smaller than at least one of a background image of a first video or a background image of a second video, when switching from the first video viewable from a first viewpoint to the second video viewable from a second viewpoint different from the first viewpoint.
